(19) United States
(12) Patent Application Publication
(10) Pub. No.: US 2013/0199324 A1
(43) Pub. Date: Aug. 8, 2013

(54) BALL SCREW ASSEMBLY

(71) Applicants: Daniel J. PILTZ, Ravenna, OH (US); Alexander S. MARGOLIN, Solon, OH (US); Steven J. DENNEY, Parma Heights, OH (US); Joseph H. NOOK, III, Munson, OH (US)

(72) Inventors: Daniel J. PILTZ, Ravenna, OH (US); Alexander S. MARGOLIN, Solon, OH (US); Steven J. DENNEY, Parma Heights, OH (US); Joseph H. NOOK, III, Munson, OH (US)

(73) Assignee: NOOK INDUSTRIES, Cleveland, OH (US)

(21) Appl. No.: 13/748,331

(22) Filed: Jan. 23, 2013

Related U.S. Application Data
(60) Provisional application No. 61/590,135, filed on Jan. 24, 2012.

(51) Int. Cl. F16H 25/22

(52) U.S. Cl. CPC F16H 25/2223
USPC 74/424.86

(57) ABSTRACT

A ball screw assembly having a bearing ball recirculation arrangement. The ball screw assembly includes a ball screw, a nut, and at least one set of two return plugs and at least one cap. The nut body is in threaded engagement with the ball screw, wherein one of the ball screw and the nut body is rotationally fixed relative the other. Each plug may be seated into a cavity on an outer surface of the nut body. The cap may have a recessed channel at least partially defining a return path for bearing balls from one end of a load bearing path to another end of a load bearing path.

### CROSS-REFERENCE TO RELATED APPLICATION

This application claims the benefit of United States Provisional Patent Application Ser. No. 61/590,135, entitled BALL SCREW ASSEMBLY and filed Jan. 24, 2012, the entire disclosure of which is incorporated herein by reference, to the extent that it is not conflicting with the present application.

### BACKGROUND

Certain mechanical assemblies are designed to translate rotary motion into linear motion, such as for example, a ball screw assembly, which is a well-known arrangement offering relatively high efficient and low friction. A typical ball screw assembly has a number of bearing balls that transfer the load between the screw and the nut, while the nut moves linearly relative the longitudinal axis of the screw. In a common arrangement, one of either the screw and the nut rotate while the other is held stationary, depending on among other things, the application of the ball screw. In operation, the bearing balls travel around the screw within the threads, and migrate toward a distal end of the ball screw assembly. A typical ball screw assembly is a closed mechanism, and thus, must include a recirculation arrangement to deflect the bearing balls out of a ball nut and a ball screw, and return them to the start of the ball circuit to allow the bearing balls to re-enter the load bearing path.

Examples of typical ball screw returns include external returns and internal returns. These two types of returns are generally designed and manufactured uniquely for each ball screw assembly based on application requirements, e.g., ball screw diameter, screw pitch, ball screw lead, ball diameter, and screws starts, i.e., independent threads of the shaft. In other words, each type of return offers little to no efficiencies in design, manufacturing, or inventory over multiple applications. i.e., a variety of different applications.

A prior art ball screw assembly 10 having an exemplary external return is illustrated in FIGS. 1-3. The assembly 10 includes a nut body 14 positioned co-axially on a screw shaft 12 and, in application, prohibited from rotational movement by structure (not shown). The nut 14 moves linearly along the longitudinal axis L₁ of the screw 12 (see FIG. 2). An external tube 16 provides a return path for bearing balls 22 from a nut exit 24 to a nut input 26. As known in the art, either passage 24, 26 may act as a nut exit or a nut input, depending on the rotational direction of the screw. The tube 16 is secured to the nut 14 by a bracket 18 and mechanical fasteners 20. FIG. 3 is a sectional view along the axis of the tube 16. It should be understood that other external return ball screw returns exist with one or more similar features.

A prior art exemplary internal return is illustrated in FIGS. 4-6. A ball screw assembly 30 includes a nut body 34 positioned on a screw shaft 32 and; in application, prohibited from rotational movement by structure (not shown). Threads on the exterior of the shaft define a helical pattern along its length. The nut 34 moves linearly along the longitudinal axis L₂ of the screw 32 (see FIG. 5). An insert 36, or referred to as a multi-liner in the art, is positioned between the shaft and the nut along the length of the nut. The insert 36 includes a plurality of separate return paths 38 in which the travel path of a ball 40 about the circumference of shaft 32 is adjusted, such that the balls do not travel along the length of the shaft, not individually, collectively or in sets. In other words, the balls are divided into groups and travel within a separate path circumferentially around the screw, i.e., in a single path of a plurality of paths. It should be understood that other internal return ball screw returns exist with one or more similar features.

### SUMMARY

The present application describes a ball screw assembly having a bearing ball recirculation arrangement.

In an exemplary embodiment, the ball screw assembly includes a ball screw, a nut, at least one set of return plugs and at least one cap. The nut body is in threaded engagement with the ball screw, wherein one of the ball screw and the nut body is rotationally fixed relative the other. Each plug may be inserted into a cavity on an outer surface of the nut. The at least one cap may have a recessed channel at least partially defining a return path for bearing balls from one end of a load bearing path to another end of a load bearing path.

### BRIEF DESCRIPTION OF THE DRAWINGS

Features and advantages of the general inventive concepts will become apparent from the following detailed description made with reference to the accompanying drawings.

FIG. 1 is a perspective view of a prior art ball screw assembly having an external ball return;

FIG. 2 is a sectional view of the ball screw assembly of FIG. 1, shown along a longitudinal axis of the screw;

FIG. 3 is a sectional view of the ball screw assembly of FIG. 1, shown along a longitudinal axis of a return tube;

FIG. 4 is a perspective view of a prior art ball screw assembly having an internal ball return;

FIG. 5 is a sectional view of the ball screw assembly of FIG. 4, shown along a longitudinal axis of the screw;

FIG. 6 is a sectional view of the ball screw assembly of FIG. 4, shown along a longitudinal axis of a screw and without the screw;

FIG. 7 is perspective view of an exemplary embodiment of a ball screw assembly, the assembly having a single path return;

FIG. 8 is an exploded view of the ball screw assembly of FIG. 7, shown from the opposite side of the assembly and without the screw;

FIG. 9 is a sectional view of the ball screw assembly of FIG. 7, shown along a longitudinal axis of the screw;

FIG. 10 is a sectional view of the ball screw assembly of FIG. 7, shown along a longitudinal axis of a return path;

FIG. 11 is perspective view of another exemplary embodiment of a ball screw assembly, the assembly having a dual path return;

FIG. 12 is an exploded view of the ball screw assembly of FIG. 11, shown without the screw;

FIG. 13 is a sectional view of the ball screw assembly of FIG. 11, shown along a longitudinal axis of the screw;

FIG. 14 is a sectional view of the ball screw assembly of FIG. 11, shown along a longitudinal axis of one of the dual return paths;

FIG. 15 is a top perspective view of an exemplary embodiment of a cap;

FIG. 16 is a bottom perspective view of the cap of FIG. 15;

FIG. 17 is a top perspective view of an exemplary embodiment of a nut;

FIG. 18 is a side perspective view of an exemplary embodiment of a return plug;

FIG. 19 is a top perspective view of the return plug of FIG. 18;

FIG. 20 is a left side view of the return plug of FIG. 18;

FIG. 21 is a front view of the return plug of FIG. 18;

FIG. 22 is a top view of the return plug of FIG. 18;

FIG. 23 is a bottom view of the return plug of FIG. 18;

FIG. 24 is a sectional view of the return plug of FIG. 18, shown along the lines 24-24 of FIG. 22;

FIG. 25 is a perspective sectional view of the return plug of FIG. 18, shown along the lines 25-25 of FIG. 22; and

FIG. 26 is a sectional view of the return plug of FIG. 18, shown along the lines 25-25 of FIG. 22.

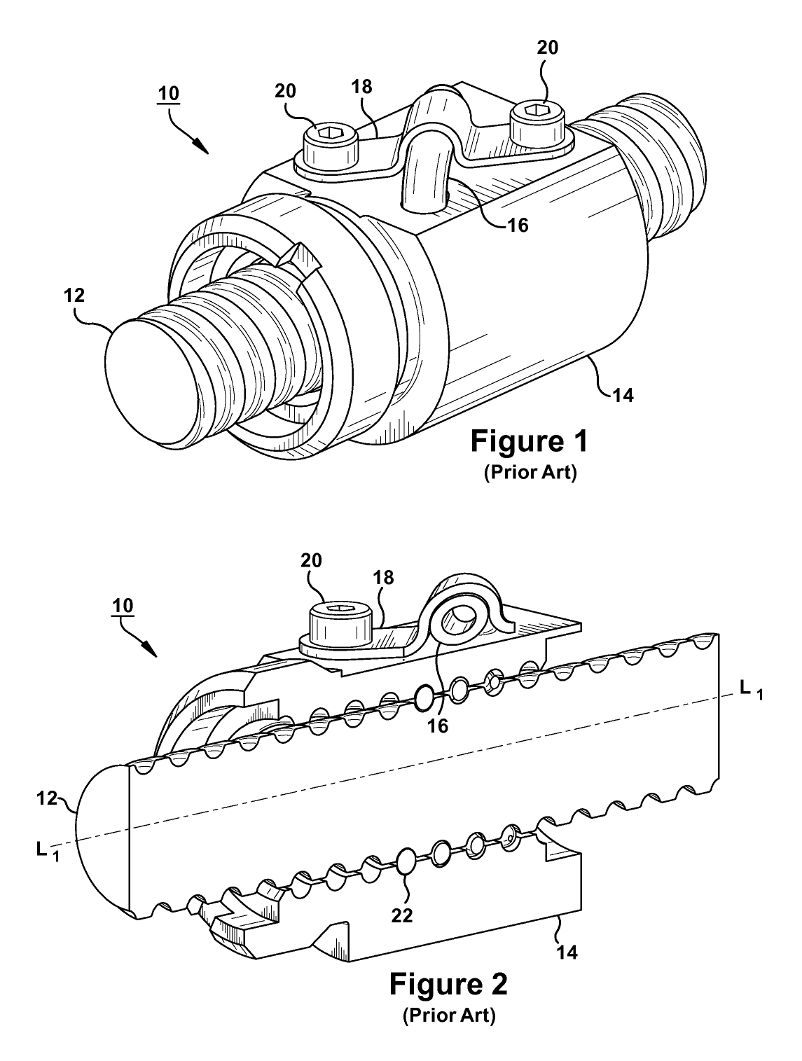

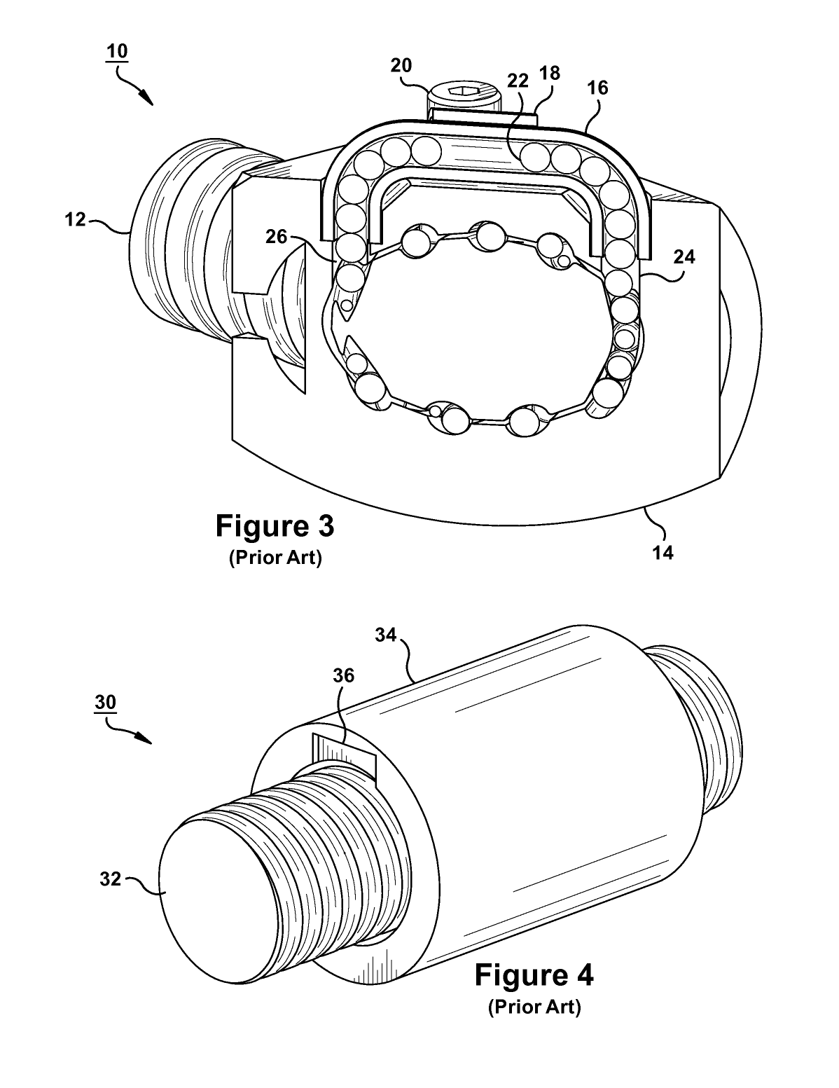

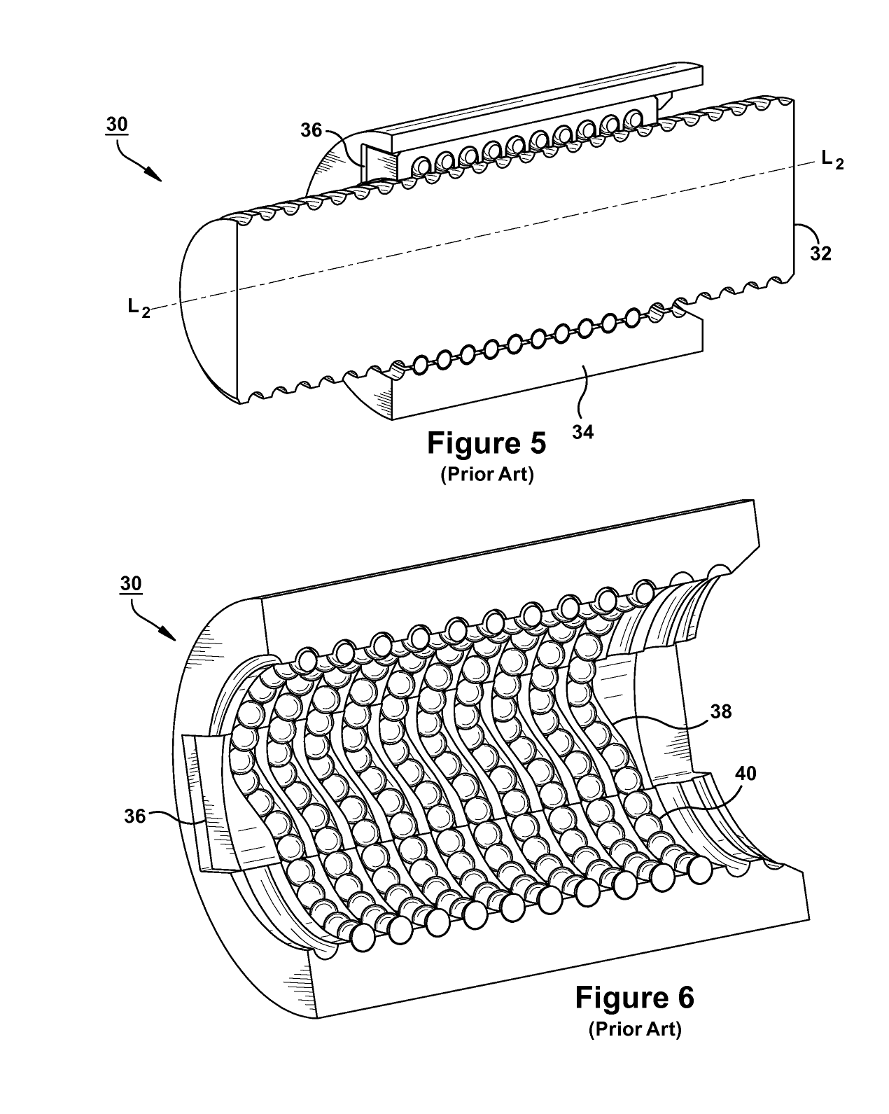

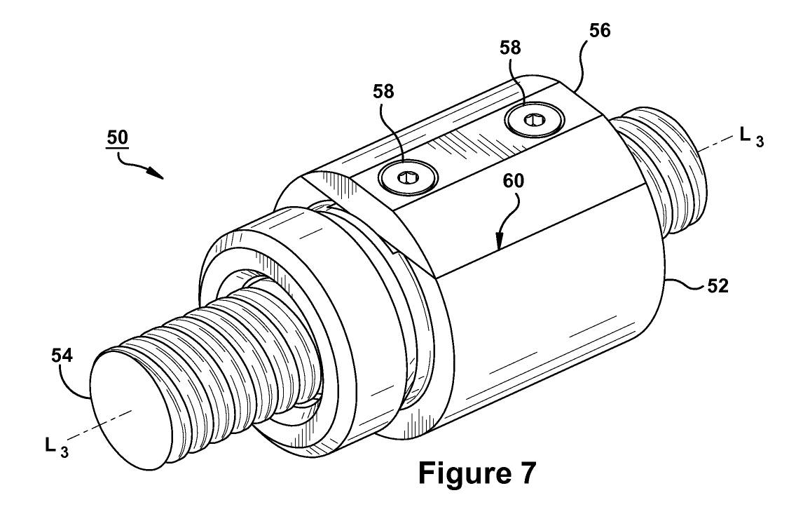

### DETAILED DESCRIPTION

This Detailed Description merely describes exemplary embodiments in accordance with the general inventive concepts and is not intended to limit the scope of the invention or the claims in any way. Indeed, the invention as described by the claims is broader than and unlimited by the exemplary embodiments set forth herein, and the terms used in the claims have their full ordinary meaning

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise.

Unless otherwise indicated, all numbers expressing quantities of ingredients, properties such as molecular pressure source, reaction conditions, and so forth as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

The present invention relates to a ball screw assembly having recirculation features to generally transfer balls from the load bearing path of the ball screw to a return path, and to generally transition the balls along the return path back to the start of the circuit. An inventive assembly and method utilizes an engagement, or pick-up, feature, such as for example, a pick-up finger, at the end of the load path, and at the end of the return path. The exemplary pick-up finger may be intergraded into a single plug or insert, such as for example, a flag return.

In an exemplary embodiment, the pick-up finger portion may deflect the ball from the load bearing path into the return path. An exemplary return plug has a concave portion with a radius that creates a smooth transition to the return path between a nut body and a cap. The return plug may be assembled into the ball nut body and secured in place with the cap and mechanical fasteners. When the ball reaches the end of the ball path, the ball contacts a second flag return which directs the ball back into the load bearing path. The second flag return may be similar or identical to the first flag in shape, size or style. A flag may be used at only the beginning or at only the end of the return path.

The present invention includes a ball return plug that may be seated in the ball nut body at either end of a return path. The path is defined by an elongated recess in either or both of a cap and a ball nut body. Common recesses in the cap and a ball nut body may align with each other. The return plug may guide the travel of balls into the return path at a path entrance and out of the return path at a path exit. The use of the return plug and cap with a particular ball diameter offer flexibility across different ball screw diameters, length and lead variations. Thus, the need for specially designed and manufactured return (recirculation) devices for each particular application is reduced.

In general, features of a return device are based at least in part on the ball screw diameter, lead and ball size. As the diameter and lead change, the angular position of the return path relative the ball screw must also change for preferred performance results. Using the return plug, the position of the return channel may be modified to accommodate the diameter and lead of the ball screw assembly. Also, the ball return path may be modified, for example, between the nut body and cap, to account for any variations in diameter and lead of the ball screw assembly. Thus, the same return plug may be used in many ball screw assemblies having multiple combinations of different diameters and leads. With the cap in a secured position, the cap and associated hardware may be sized and positioned to not extend beyond the diameter of the ball nut.

A flag return assembly avoids many negative or troublesome design, manufacturing and assembly issues commonly associated with the internal style return and the external style return. The flag style return assembly may incorporate a compact design envelope, while keeping any ball recirculation areas out of the loaded path creating a smooth rolling ball screw assembly. The design may be used across diameter and lead variations for the same ball diameter resulting in large single part quantities, lowering part cost and increasing the ability to forecast and manufacture stock.

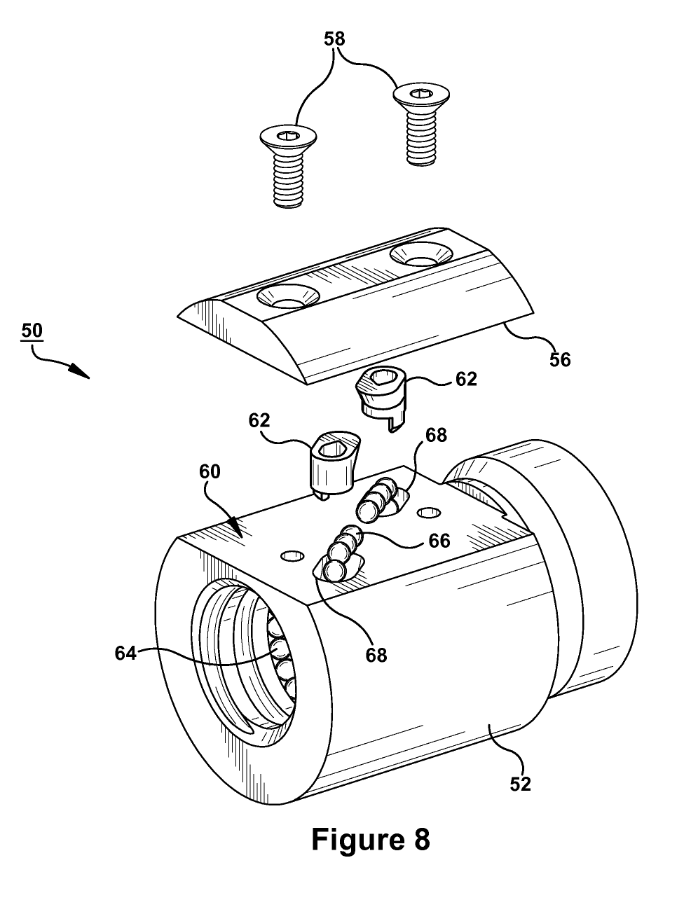

Referring now to the drawings, an embodiment on the invention having a single recirculation path is shown in FIGS. 7-10. The exemplary ball screw assembly 50 includes a ball nut body 52 positioned on a screw shaft 54 and, in application, prohibited from rotational movement by structure (not shown). The nut body 52 moves linearly along the longitudinal axis L₃ of the screw 54. A cap 56 is secured in place by mechanical fasteners 58 to an outer surface of the nut 52. In a secured position, the underside of the cap 56 rests on a planar surface 60 of the nut 52 (see FIG. 8), effectively filling a void in the outer surface of the nut. In one embodiment, the cap may include a recess to engage a portion of the flag return extending above the nut body.

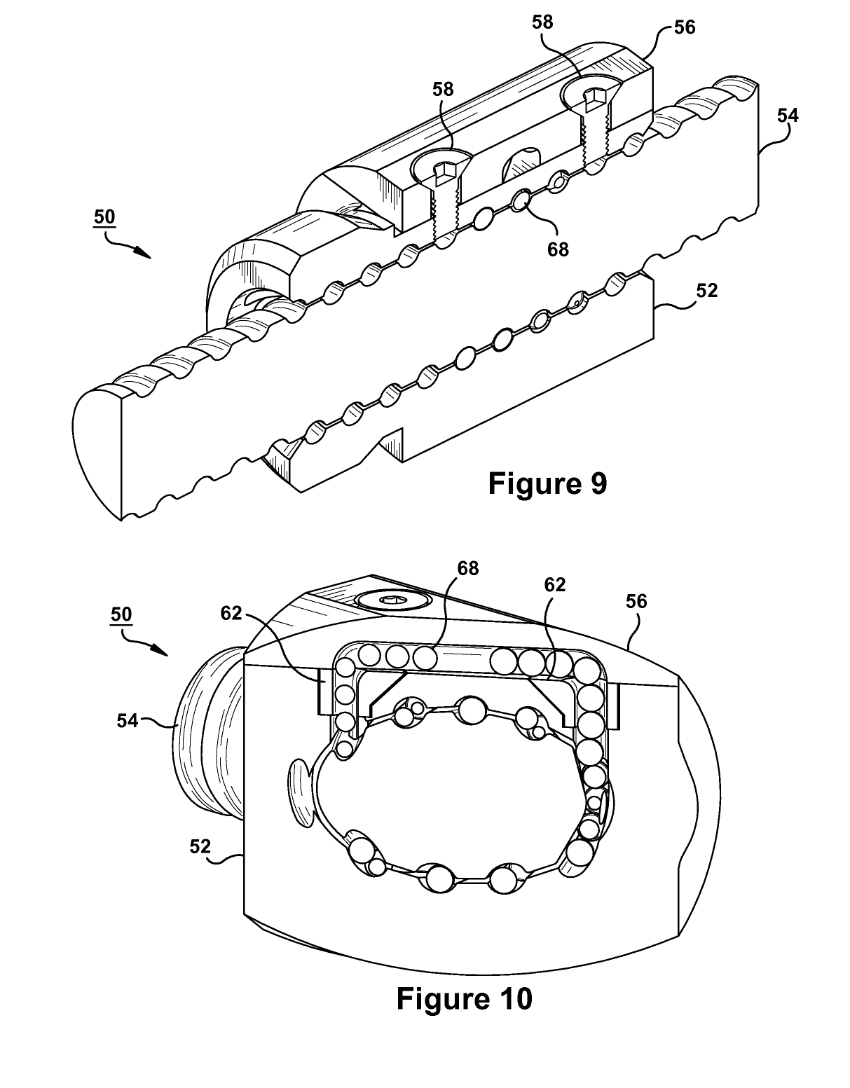

FIG. 8 is an exploded view of the ball screw assembly 50. A set of return plugs 62 are positioned “flag down” into two separate cavities 68 in the top surface of the nut 52. With the screw not shown, the balls 64 are illustrated within the nut 52 and also along a return path between the nut and the underside of the cap 56. Also, certain balls 68 are visible in the ball path in the sectional views shown in FIGS. 9 and 10. Balls 68 in the return path are shown in FIG. 10, which is a sectional view along the axis of the return recess in the cap 56. To be discussed in greater detail, the return plugs 62 rest at or below the top surface 60 of the nut body 52 and a desired orientation, for example, with the flag off-set from a longitudinal axis of the return path. As discussed, the cap may include a recess to lock in a portion of the return plug 62 extending above the nut body.

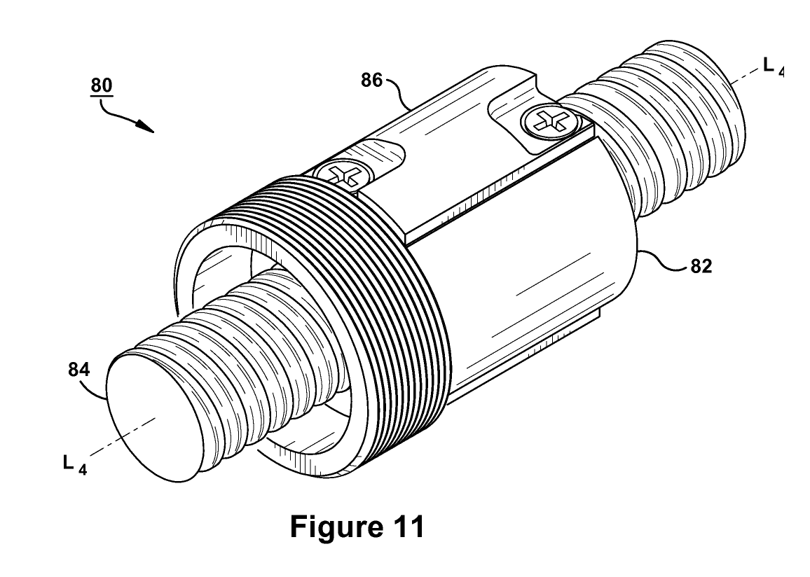

Another embodiment on the invention is shown in FIGS. 11-14. A ball screw assembly 80 is illustrated with dual return paths in FIG. 11. The ball screw assembly 80 includes a ball nut body 82 positioned on a screw shaft 84 and, in application, prohibited from rotational movement by structure (not shown). The nut moves linearly along the longitudinal axis L₄ of the screw 84. A cap 86 is secured in place by mechanical fasteners 88 to an outer surface of the nut 82 in two places, preferably at opposing sides as shown in FIG. 12. However, the invention may be practiced with ball screw assemblies having more than two return paths. In a secured position, the underside of the cap 86 rests on a planar surface 90 of the nut 82, effectively filling a void in the outer surface of the nut, and forming an assembly 80 with a circular shaped outer surface.

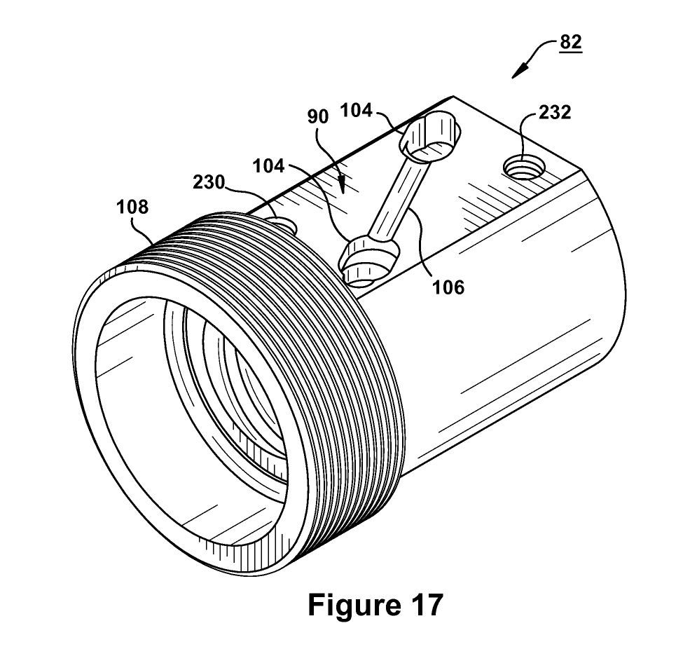

As mentioned, FIG. 12 is an exploded view of the ball screw assembly 80. The return plugs 92 are positioned “flag down” into a cavity 104 (see FIG. 17) in the top surface 90 of the nut 82. With the screw not shown, the balls 94 are illustrated along the return path between the top surface 90 of the nut and the underside of the cap 86.

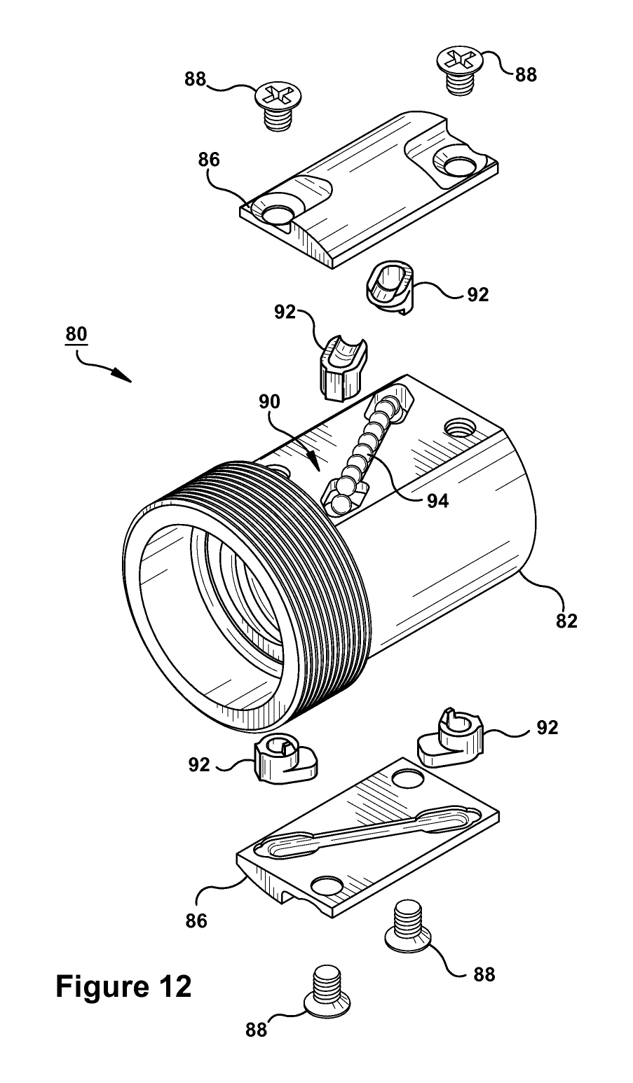

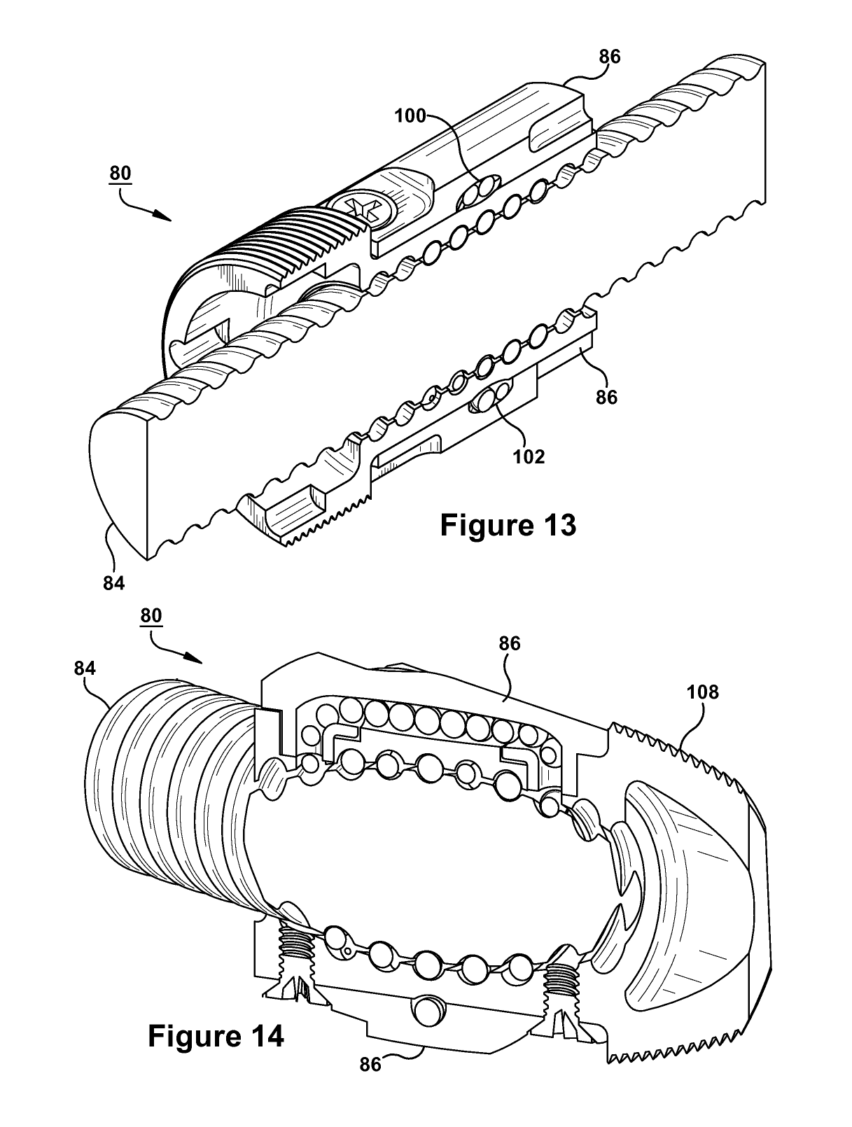

A sectional view of the assembly 80 in FIG. 13 illustrates the intersecting pattern of the dual return feature. Certain balls are visible in the ball path in the sectional view. Balls are also shown within return paths 100, 102, respectively, of the top cap and bottom cap. In FIG. 14, balls are shown along the return path 100 of the top cap 56, which is a sectional view along the axis of the return recess in the top cap 56.

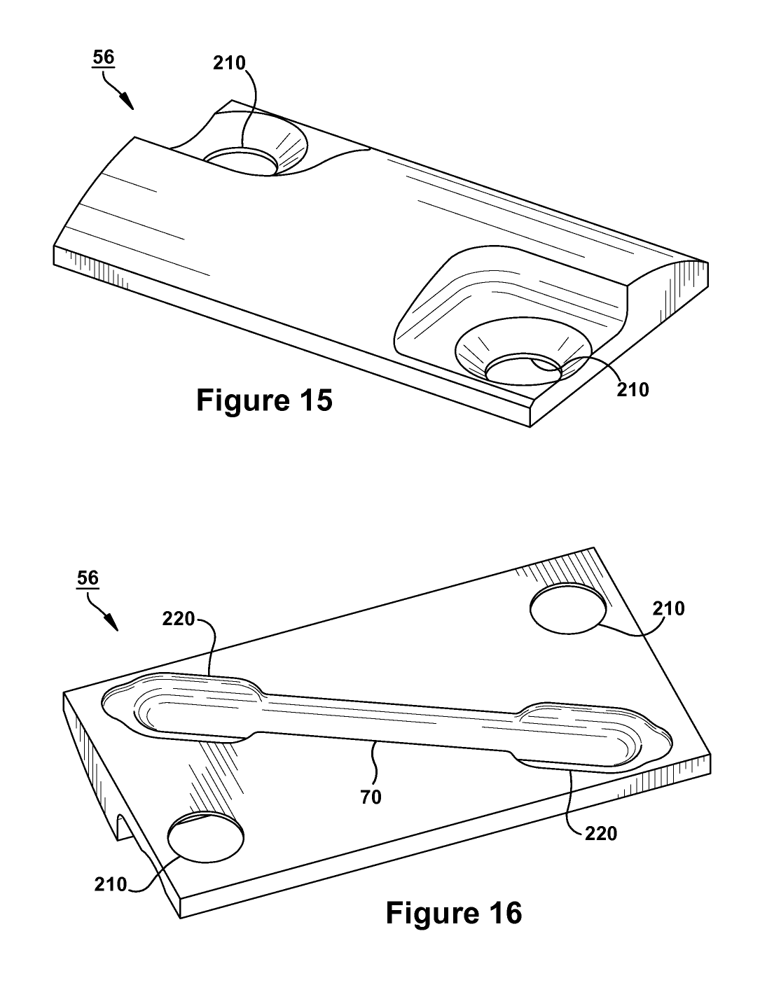

Top and bottom perspective views of the cap 56 are shown in FIGS. 15 and 16, respectively. A cap of this design may also be used for an assembly only having one return path. A recessed channel forms at least part of the return path for balls outside of the load bearing path. A single cap component, i.e., of one size and shape, may be used in multiple applications. For example, two caps of the same size may be used on either side of a dual path ball screw, or a cap designed for a particular ball screw diameter may be used with certain ball screws of greater size. In the exemplary cap shown in FIGS. 15 and 16, a return path is partially defined by a longitudinal recess 70 between recesses 220. Each recess may act as a starting recess or an ending recess. Apertures 210 provides mounting holes for hardware as shown in the exemplary ball screw assembly illustrated in FIG. 12.

The nut body 82 of the dual return assembly 80 is shown in FIG. 17. The top surface 90 includes cavities 104 for insertion of the return plugs 92. A return channel 106 extends between the cavities and defines a portion of the ball return path, aligning with the recessed channel 70 of the cap 56. The nut includes an exemplary threaded portion 108, and mounting holes 230, 232 are provided for securing a cap. The invention may be practiced with nuts of a wide variety of designs, and nuts having features necessary for adaption in an application environment.

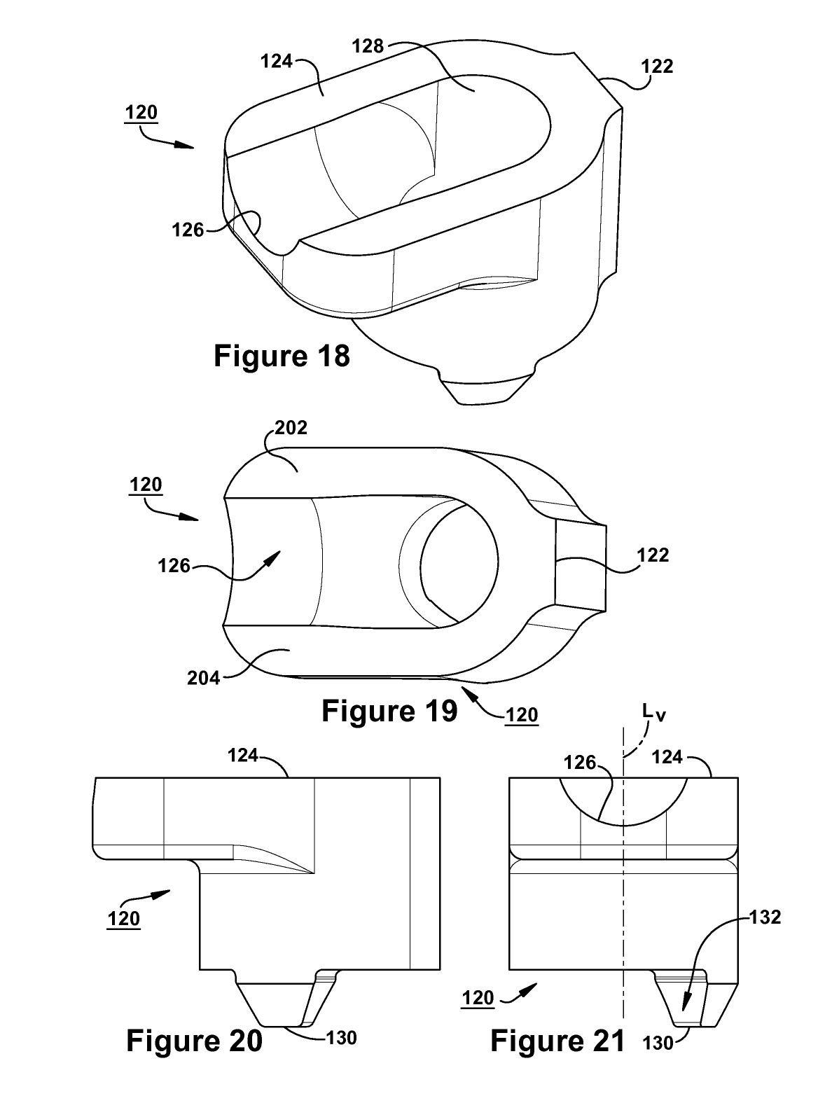

As discussed herein, a return plug may direct ball travel at the beginning and at the end of the return path. FIGS. 18-26 illustrate an exemplary embodiment of a return plug 120 suitable for use at either the beginning or the end on the return path, or at both the beginning and at the end. As discussed, a single return plug may be used at each end of a return path. For example, four return plugs of the same size may be used in a dual return ball screw assembly. As show, the return plug is an integral design, but a part assembled of multiple pieces may be used in the practice of the invention.

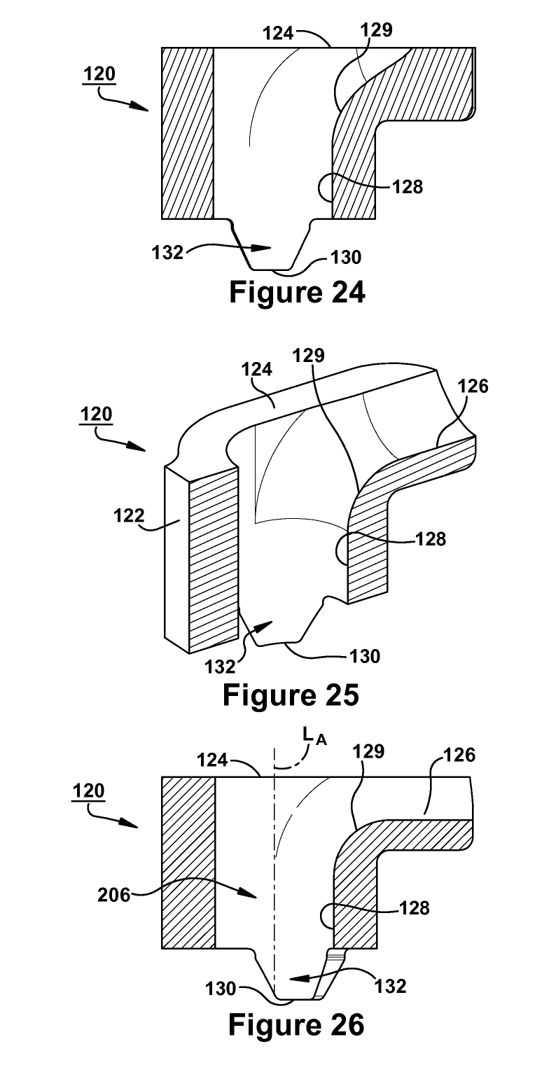

In an exemplary ball screw assembly, the return 120 is inserted into a cavity within a nut body. A rib 122 may be used to orient the return 120 into a cavity of the nut. In position within the cavity, a top surface 124 may rest flush with, below or above the top surface of the nut body, allowing the bottom surface of the cap to contact the nut body. As illustrated in the two embodiments of FIGS. 7-17, the return 120 is seated into a cavity. A horizontal channel 126 of the return 120 has a radius to accommodate a particular ball size, or more than one ball size, and is co-axially aligned to direct balls into and out of the return path . As seen in FIGS. 19 and 20, the horizontal channel 126 divides a top half of the return into a first ledge 202 and a second ledge 204. As best seen in FIGS. 24-26, a vertical channel 128 has a radius to accommodate the same particular ball size, or ball sizes, and directs balls into and out of the load path of the screw and nut assembly. A transition channel may be formed between the two channels. As illustrated, a transition channel 129 is formed as a circular 90 degree bend. Other channel shapes and combinations of shapes may be used in the practice of this invention.

A ball moving at the rotational and linear end of the load path must travel back to the beginning of the closed circuit. A flag, or pick-up finger, engages each ball as it reaches the end of the load path, and provides a portion of a return path for the ball. For example, FIGS. 18-28 show a return plug having an exemplary flag 130. FIGS. 18 and 19 are perspective views of the return 120.

The exemplary flag is also shaped to cooperatively interact with the vertical channel. As best seen in the sectional view of FIG. 25, the flag has a concave inner surface 132 for receiving a ball. As shown in FIG. 23, the vertical channel 128 defines a radius R which is equal to a radius of the concave surface 132 of the ball-engaging surface of the flag 130. The radius of the flag 132 and the radius of vertical channel 128 also share a common center point (see FIG. 23).

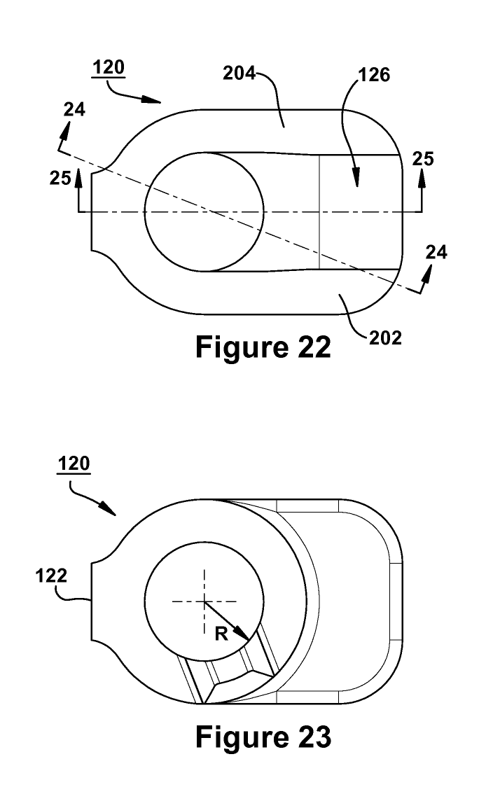

The flag may be positioned relative the vertical channel to improve ball pick up and ball return performance. As shown in FIG. 23, the exemplary flag 130 is positioned off-set the longitudinal axis of the recessed channel of the cap, and horizontal channel of the return. For example, and referring to FIG. 22, the line 25-25 is co-axial with the longitudinal axis of the recessed channel and the horizontal channel 126, but the line 24-24 is along the center point of the inner surface of the flag. In other words, the flag is positioned relative the circumference of the vertical channel in a position orientated toward the front half of the vertical channel, that is to say, toward the front of the return plug 120. For example, the flag 130 is positioned on a portion of the vertical channel toward the horizontal channel 126 relative the longitudinal axis L_{A} of the vertical channel 128. Further, as seen in FIG. 21, the flag 130 is positioned off-center from the sagittal plane Lᵥ of the return plug 120. The off-set position of the flag 130 is also shown in FIG. 24, which is a sectional view of the return plug of FIG. 18, shown along the lines 24-24 of FIG. 22.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, circuits, devices and components, software, hardware, control logic, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A ball screw assembly having a bearing ball recirculation arrangement, the assembly comprising:
a ball screw;
a nut body in threaded engagement with the ball screw, wherein one of the ball screw and the nut body is rotationally fixed relative the other;
at least one set of two return plugs, each plug inserted into a cavity on an outer surface of the nut body; and
at least one cap having a recessed channel at least partially defining a return path for bearing balls from one end of a load bearing path to another end of a load bearing path.

2. The ball screw assembly of claim 1 wherein at least one return plug has a protruding flag to engage bearing balls exiting or entering the load bearing path.

3. The ball screw assembly of claim 1 wherein each of the return plugs are integral.

4. The ball screw assembly of claim 1 wherein each of the return plugs are identical.

5. The ball screw assembly of claim 1 wherein the nut body has a recessed channel at least partially defining a return path for bearing balls.

6. The ball screw assembly of claim 5 wherein the recessed channel of the nut body and the recessed channel of the cap are cooperatively shaped to define a length of the return path for bearing balls.

7. The ball screw assembly of claim 1 further comprises a set of bearing balls.

8. The ball screw assembly of claim 1 wherein at least one of the return plugs defines a ball bearing travel path that includes a horizontal channel and a vertical channel.

9. The ball screw assembly of claim 2 wherein at least one of the return plugs defines a ball bearing travel path that includes a horizontal channel, a vertical channel and an inner surface of the protruding flag.

10. The ball screw assembly of claim 9 wherein the inner surface is concave.

11. The ball screw assembly of claim 9 wherein the inner surface of the protruding flag defines a radius equal to a radius defined by an inner surface of the vertical channel.

12. The ball screw assembly of claim 9 wherein the radius defined by the inner surface of the protruding flag has a common center point with the radius defined by an inner surface of the vertical channel.

13. A ball screw assembly having a closed bearing ball recirculation path, the assembly comprising:
a ball screw;
a nut in threaded engagement with the ball screw;
at least one cap secured to the nut, the inner surface of the cap having a recessed channel at least partially defining a length of the recirculation path; and
at least two return plugs, each plug seated into a cavity in the outside surface of the nut.

14. The ball screw assembly of claim 13 wherein the outer surface of the nut has a recessed channel, and the recessed channel of the nut and the recessed channel of the cap are cooperatively shaped to define a length of the recirculation path.

15. The ball screw assembly of claim 13 wherein at least one of the at least two return plugs has a protruding flag to engage bearing balls exiting or entering the recirculation path.

16. The ball screw assembly of claim 13 wherein the at least two return plugs are integral and are identical.

17. The ball screw assembly of claim 13 wherein each of the at least two return plugs defines a ball bearing travel path that includes a horizontal channel and a vertical channel.

18. The ball screw assembly of claim 15 wherein each of the two return plugs defines a ball bearing travel path that includes a horizontal channel, a vertical channel and a concave inner surface of the protruding flag.

19. The ball screw assembly of claim 18 wherein the inner surface of the protruding flag defines a radius equal to a radius defined by an inner surface of the vertical channel.

20. The ball screw assembly of claim 18 wherein the radius defined by the inner surface of the protruding flag has a common center point with the radius defined by an inner surface of the vertical channel.

21. The ball screw assembly of claim 18 wherein at least one return plug is positioned at an end of the recessed channel in the cap and with the concave inner surface of the protruding flag off-center from a longitudinal axis of the recessed channel of the cap.
